(19) United States
(12) Patent Application Publication
(10) Pub. No.: US 2013/0326591 A1
(43) Pub. Date: Dec. 5, 2013

(54) WIRELESS COMMUNICATION DEVICE AND WIRELESS COMMUNICATION METHOD

(71) Applicant: KABUSHIKI KAISHA TOSHIBA, Tokyo (JP)

(72) Inventor: Kyungwoon JANG, Kawasaki-shi (JP)

(73) Assignee: KABUSHIKI KAISHA TOSHIBA, Tokyo (JP)

(21) Appl. No.: 13/781,410

(22) Filed: Feb. 28, 2013

(30) Foreign Application Priority Data
Jun. 1, 2012 (JP) 2012-126288

(51) Int. Cl. H04W 12/08

(52) U.S. Cl. CPC H04W 12/08
USPC 726/4

(57) ABSTRACT

According to an embodiment, a wireless communication device includes a wireless communication unit, a control unit and a storage unit. The wireless communication unit is configured to perform close proximity wireless communication or near-distance wireless communication with other wireless communication device. The storage unit is configured to store data and setting parameters associated with the data. The setting parameters include presence or absence of a lock function and transfer-permitting information. The control unit activates the wireless communication unit when a user is the authorized user. After the control unit activates the wireless communication unit, when the lock function is present in the setting parameters, the control unit determines whether a transfer permission is present based on the transfer-permitting information. When determining that the transfer permission is present, the control unit causes the wireless communication unit to transfer the data.

### CROSS REFERENCE TO RELATED APPLICATION

This application is based upon and claims the benefit of priority from the prior Japanese Patent Application No. 2012-126288 filed on Jun. 1, 2012 in Japan, the entire contents of which are incorporated herein by reference.

### FIELD

Embodiments described herein relate generally to a wireless communication device and a wireless communication method.

### BACKGROUND

TransferJet (trademark) is a near-distance/close proximity wireless communication technique which is currently attracting attention. The TransferJet-equipped devices are touched to distribute and share contents easily and quickly. However, use cases which require secure processing and management against careless use or unexpected use in terms of contents protection increase.

### BRIEF DESCRIPTION OF THE DRAWINGS

FIG. 1 is a block diagram illustrating a structure of a wireless communication device according to one embodiment.

FIG. 2 is a diagram for explaining a boot processing of a wireless communication unit in the wireless communication device according to one embodiment.

FIG. 3 is a flowchart illustrating a data transfer management method of the wireless communication device according to one embodiment.

### DETAILED DESCRIPTION

According to an embodiment, a wireless communication device includes a wireless communication unit, a control unit and a storage unit. The wireless communication unit is configured to perform close proximity wireless communication or near-distance wireless communication with other wireless communication device. The control unit is configured to control the wireless communication unit. The storage unit is configured to store data and setting parameters associated with the data. The setting parameters include presence or absence of a lock function and transfer-permitting information. The control unit confirms whether a user is an authorized user of the device, activates the wireless communication unit when the user is the authorized user, and does not activate the wireless communication unit when the user is not the authorized user. After the control unit activates the wireless communication unit, when the lock function is present in the setting parameters, the control unit determines whether a transfer permission is present based on the transfer-permitting information in the setting parameters. When determining that the transfer permission is present, the control unit causes the wireless communication unit to transfer the data, and when determining that the transfer permission is not present, the control unit does not cause the wireless communication unit to transfer the data.

The TransferJet technique known to the present inventor will be described prior to explaining an embodiment of the present invention.

TransferJet is considered as an important technique for distributing contents between devices in the future since it enables stable and rapid data transfer with simple operations.

TransferJet realizes rapid data transfer of 560 Mbps at maximum and 375 Mbps at effective throughput when a user only “touches” it. The communicable distance is several centimeters at maximum and the connection form (network topology) is always point-to-point. The communicable distance and the connection form make the system so simple. Since the communication distance is short, close proximity wireless communication can be made at remarkably low transmission power such as −70 dBm/MHz or less. The setting and management of the network can be largely simplified due to the point-to-point connection form. Each TransferJet device makes detection only when other device enters its communicable distance range. Transmission is performed only when other device is detected, thereby achieving power saving. This is an advantage of the touch model.

Contents can be distributed and shared easily and rapidly between the TransferJet devices. Thus, a malicious user can distribute and share copyrighted paid contents without permission. In recent years, decryption techniques are being developed along with the development of encryption techniques.

Thus, simple encryption of contents is not sufficient. Particularly, personal information, paid contents and parental locked contents should be protected and managed against careless use or unexpected use.

Further, more reliable security systems are remarkably important in consideration of a combination with an accounting/authenticating system such as NFC (Near Field Communication).

The inventor has made the present invention based on the above knowledge.

One embodiment of the present invention will be described below with reference to the drawings. The present invention is not limited to the embodiment.

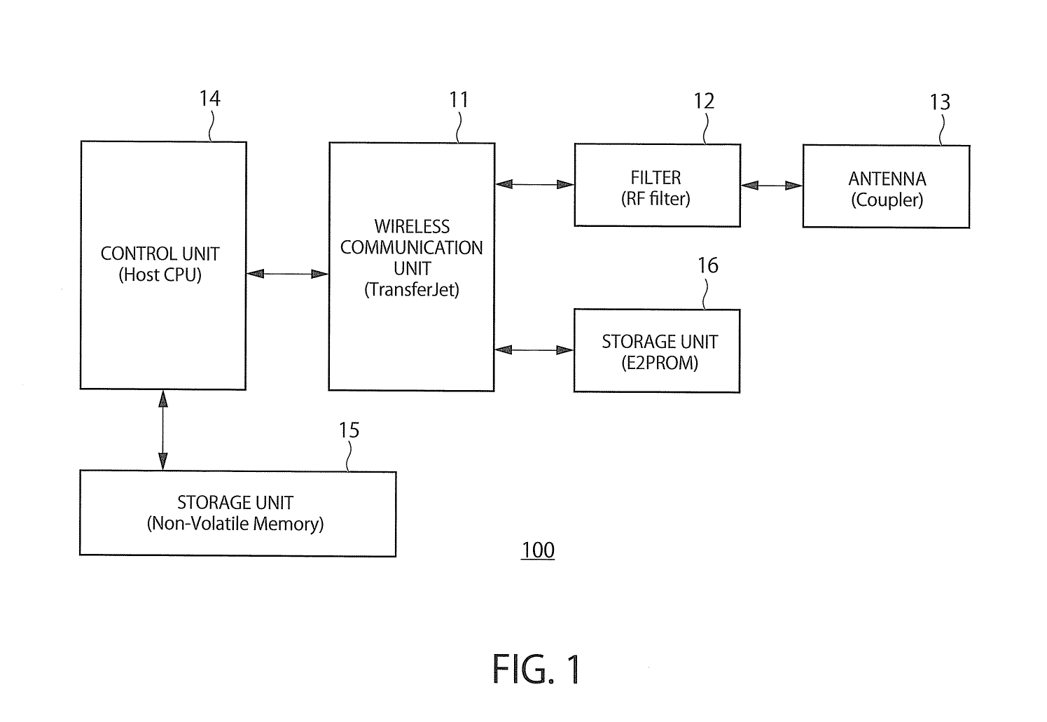

FIG. 1 is a block diagram illustrating a structure of a wireless communication device 100 according to one embodiment of the present invention. The wireless communication device 100 in FIG. 1 is configured to perform point-to-point close proximity wireless communication or near-distance wireless communication with other wireless communication device (not illustrated).

In the present embodiment, the close proximity wireless communication indicates wireless communication which is made when the wireless communication device 100 contacts with other wireless communication device or when it is as close as several centimeters thereto. A wireless communication system (communication standard) of the close proximity wireless communication is TransferJet, for example. The near-distance wireless communication indicates wireless communication which is made within several tens meters, for example. A wireless communication system of the near-distance wireless communication is Bluetooth (trademark) or wireless LAN, for example.

In the present embodiment, the following explanation will be made assuming that the wireless communication device 100 and other wireless communication device perform close proximity wireless communication by use of the same wireless communication system of TransferJet. That is, the wireless communication device 100 and other wireless communication device are TransferJet-equipped devices, and the TransferJet-equipped devices perform close proximity wireless communication.

For example, the wireless communication device 100 and other wireless communication device may be configured as a portable electronic device such as Smartphone, respectively, but are not limited thereto.

As illustrated in FIG. 1, the wireless communication device 100 includes a wireless communication unit (TransferJet) 11, a filter (RF Filter) 12, an antenna (Coupler) 13, a control unit (Host CPU) 14, a storage unit (Non-Volatile Memory) 15, and a storage unit (E2PROM) 16.

The wireless communication unit 11 transmits and receives a wireless signal via the filter 12 and the antenna 13 thereby to perform close proximity wireless communication with other wireless communication device. That is, the wireless communication unit 11 transmits and receives data to be transferred.

The filter 12 removes interferences of wireless signals to be transmitted and received and noises. Since the present embodiment assumes TransferJet, the antenna 13 employs a coupler capable of point-to-point fast communication whose communication distance is limited to several centimeters. When other wireless communication system is employed, the antenna 13 adapted to the wireless communication system may be employed.

The control unit 14 is a host CPU, for example, and controls the wireless communication unit 11. Specifically, the control unit 14 executes TransferJet software, and controls and manages transmitting and receiving of data by the wireless communication unit 11.

The storage unit 15 is a nonvolatile memory such as NAND flash memory, and stores TransferJet software, an activation code specific to an authorized user, data, setting parameters associated with the data, and transfer trace information associated with the data.

The data to be stored in the storage unit 15 may be data of paid and free contents acquired via Internet sites or other wireless communication devices, data of user-created contents, and the like. The contents contain music, images, animations, maps, electronic books and software, for example.

That is, the storage unit 15 may store multiple pairs of data of multiple contents, and in this case, stores multiple setting parameters and multiple items of transfer trace information associated with each pair of data.

For paid contents, for example, the setting parameters belong to the contents data, and the user can acquire the setting parameters when the user purchases and downloads paid contents from a content distributor's (seller's) site. Alternatively, the setting parameters may be acquired from a content distributor's site independent from the contents data. In this case, the setting parameters may be set by a content distributor, and the user cannot change the setting parameters.

For free contents, the setting parameters may belong to the contents, for example. In this case, the user may or may not change the setting parameters.

For user-created contents, the user sets the setting parameters.

The setting parameters contain presence or absence of lock function, transfer-permitting information, and presence or absence of encryption instruction, for example. The transfer-permitting information contains presence or absence of initial transfer permission, permitted data range, and permitted number of transmissions, for example. As described later, in the present embodiment, when the initial transfer permission is present, the data in the permitted data range can be transferred permitted transfer times. The permitted data range is information indicating all or part of the data.

The transfer trace information contains information on data transfer (such as number of times of data transfer or number of ignored transfer requests). As described later, after data transfer is completed in response to a transfer request and after the transfer request is ignored, the control unit 14 records information on the transfer of the transfer-requested data in the transfer trace information.

The storage unit 16 is E2PROM, and stores a unique ID as identification information specific to the device, for example. Depending on the entire system structure, the unique ID may be stored in the storage unit 15 not in the storage unit 16. Since each TransferJet-equipped device has its unique ID, the wireless communication device 100 acquires a unique ID from a wirelessly-connected device, thereby identifying any wirelessly-connected device.

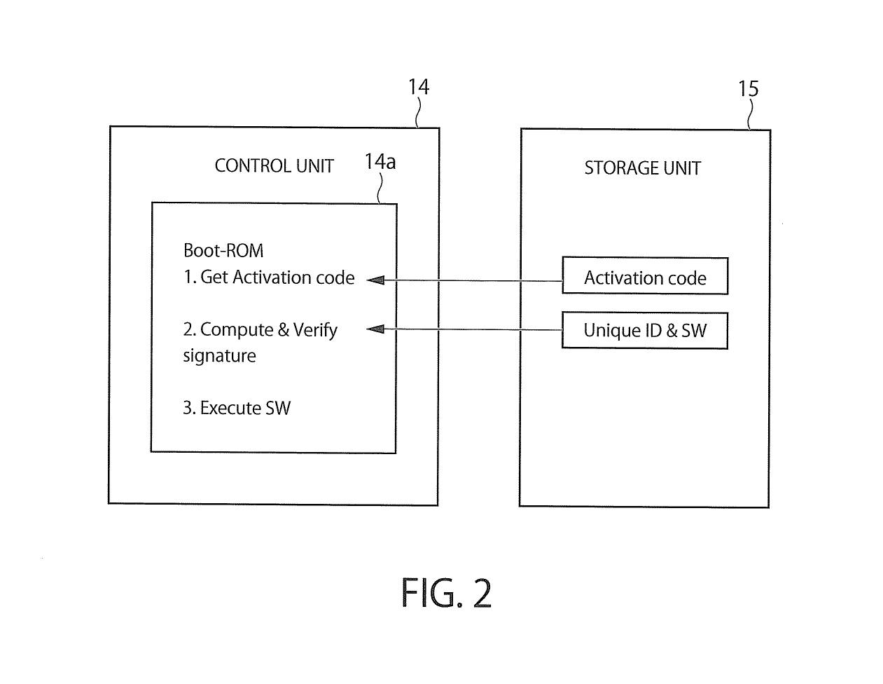

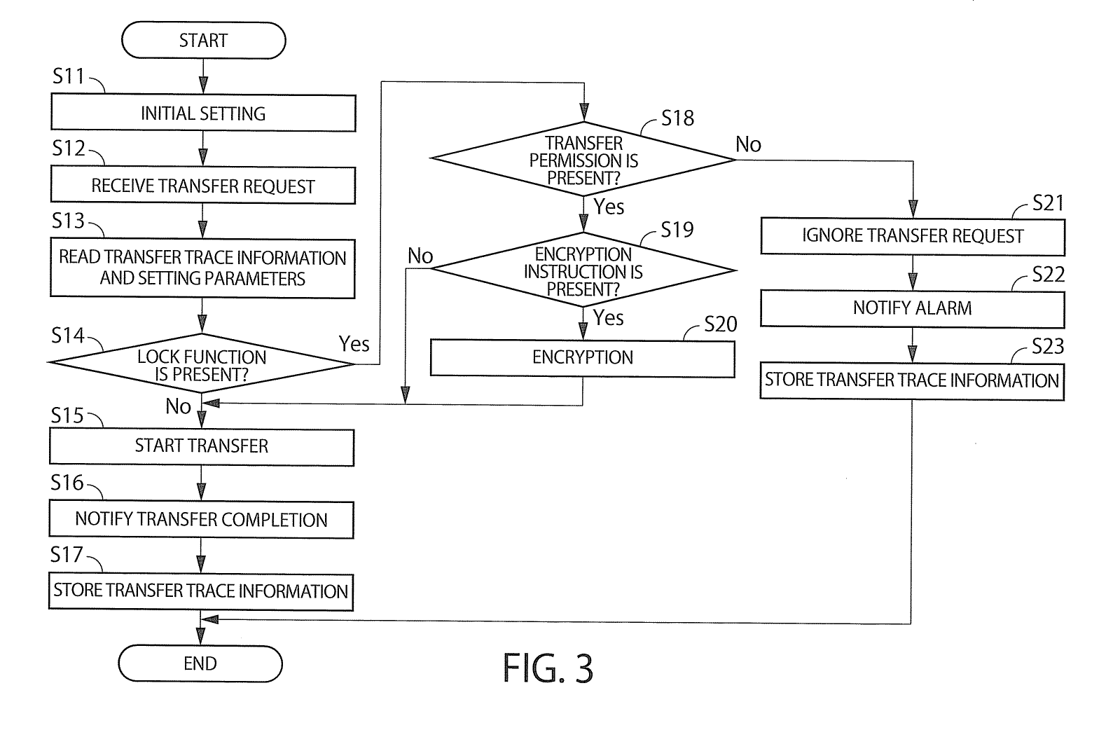

The operations of the wireless communication device 100 will be described below with reference to FIGS. 2 and 3. Herein, it is assumed that the TransferJet-equipped wireless communication device 100 and other wireless communication device transfer data in point-to-point, the wireless communication device 100 on one side is data transmission side and the other wireless communication device on the other side is data reception side.

At first, the user performs a login operation on the wireless communication device 100, the control unit 14 confirms whether the user performing the login operation is an authorized user of the device, and when the user is authorized user, activates the wireless communication unit 11, and when the user is not authorized user, does not activate the wireless communication unit 11.

FIG. 2 is a diagram for explaining a boot processing of the wireless communication unit 11 in the wireless communication device 100 according to one embodiment. As illustrated in FIG. 2, the boot processing is performed by the control unit 14 according to three procedures previously stored in a Boot-ROM 14a in the control unit 14. The Boot-ROM 14a stores procedure 1: Get Activation code, procedure 2: Compute & Verify signature, and procedure 3: Execute SW.

That is, when the user uses an input unit (not illustrated) to input user information (such as login ID) for login, the control unit 14 acquires the preset activation code from the storage unit 15 (procedure 1), and computes a correlation between the activation code and the unique ID (procedure 2). That is, the control unit 14 makes predetermined calculations between the activation code and the unique ID. In the example of FIG. 2, it is assumed that the unique ID is stored in the storage unit 15 for clarifying the explanation.

Then, when the correlation as a computation result corresponds to the user information input by the user for login, the control unit 14 confirms that the user is authorized user, executes the TransferJet software (procedure 3), and thereby activates the wireless communication unit 11 to enable a transmitting and receiving of data processing.

The activation code may be a password previously set by the authorized used, for example. The activation code may be generated by hardware and stored in the storage unit 15 whenever the user performs the login operation. When the hardware is used, PUF (Physical Unclonable Function) may be used to generate the activation code, for example, in order to enhance the security level.

At least one of the activation code and the unique ID may be encrypted and managed by an encryption key depending on the security level. The encryption key can be generated by a well-known software processing or hardware processing. When the hardware processing is performed, encryption hardware may be added to the structure of FIG. 1. That is, with the structure, whether the encryption is used may be determined by the system constitutor in consideration of cost.

When the control unit 14 does not confirm that the user performing the login operation is authorized user, the control unit 14 does not execute the TransferJet software and does not activate the wireless communication unit 11. Thus, the unauthorized user cannot perform the transmitting and receiving of data processing.

The secure boot processing is added in this way so that unexpected use by other than the authorized user can be prevented and important data such as personal information can be protected more accurately than only password is used.

After the wireless communication unit 11 is activated by the above boot processing, the wireless communication device 100 is made closer to other wireless communication device by the user to make connection or authentication with other wireless communication device, and then manages data transfer according to the flowchart described later.

FIG. 3 is a flowchart illustrating a data transfer management method of the wireless communication device 100 according to one embodiment. Each processing in the flowchart is performed by the control unit 14. As illustrated in FIG. 3, an initial setting is first performed (step S11).

Then, the user operates the input unit (not illustrated) in the wireless communication device 100 to specify data for which a transfer request is to be made from among one or a plurality of pairs of data. Thereby, the transfer request (command) is received in response to the user operation (step S12).

Then, the transfer trace information and the setting parameters associated with the transfer-requested data are read from the storage unit 15 (step S13).

Then, the presence or absence of the lock function is confirmed with reference to the read setting parameters (step S14). When the parameter of the lock function is off, or when the lock function is not present (step S14; No), transfer is rapidly started (step S15). That is, the wireless communication unit 11 is caused to transfer the transfer-requested data. When the lock function is not present, the data may be free contents or user-created contents, for example. The processings in step S16 and S17 performed after step S15 will be described.

On the other hand, when the parameter of the lock function is on, or when the lock function is present (step S14; Yes), a determination is made as to whether a transfer permission is present based on the transfer-permitting information in the setting parameters and the read transfer trace information (step S18). Specifically, when an initial transfer permission is present in the transfer-permitting information and the number of times of the data transfer in the transfer trace information is less than the permitted number of times of transfer, it is determined that a transfer permission is present. On the other hand, when the initial transfer permission is not present, and when the number of times of data transfer is equal to or more than the permitted number of times of transfer, it is determined that a transfer permission is not present.

When it is determined that a transfer permission is not present (step S18; No), the transfer request is ignored (step S21) and the wireless communication unit 11 is not caused to transfer the data. Then, an alarm signal is output, and any alarm such as a sound or a screen display is notified to the user based on the alarm signal (step S22). Thereby, the user can easily recognize that the transfer-requested data was not permitted to transfer and was not able to be transferred.

Thereafter, the number of ignored transfer requests is recorded as the information associated with the data transfer in the transfer trace information (step S23), and the processing is terminated.

On the other hand, when it is determined that a transfer permission is present (step S18; Yes), whether an encryption instruction is present is confirmed (step S19). When the parameter of the encryption instruction is on or when an encryption instruction is present (step S19; Yes), the data in the permitted data range is encrypted by use of the encryption key by the well-known software processing or hardware processing (step S20), and the wireless communication unit 11 is caused to transfer the encrypted data (step S15). When the hardware processing is performed, encryption hardware may be added to the constituent elements of FIG. 1. Other wireless communication device receiving the encrypted data needs a common encryption key for opening the data.

When the parameter of an encryption instruction is off or when an encryption instruction is not present (step S19; No), the data in the permitted data range is not encrypted and rapidly starts to be transferred (step S15). That is, the wireless communication unit 11 is caused to transfer the data without encryption.

After step S15, a transfer complete signal is output thereby to notify the user of the transfer completion by a sound or a screen display (step S16).

Thereafter, the number of times of data transfer is recorded as the information associated with the data transfer in the transfer trace information (step S17), and the processing is terminated.

The transfer trace information recorded in step S17 or step S23 is managed to be utilized depending on a use purpose of the user or content distributor (or content creator). A transfer trace information utilizing method will be described below by way of example.

Paid contents are typically configured not to be transferred or to be transferred only permitted times, but free part of the paid contents may be configured to be transferred any times. The free part may by set in the permitted data range in the transfer-permitting information of the setting parameters as described above. The user purchasing such paid contents can use the wireless communication device 100 to transfer the free part to any user. The number of times of data transfer is recorded along with the transfer as described above. Other user can determine whether to purchase the paid contents by viewing and listening to the free part. This is an exemplary application using the function called “content recommendation function”, for example.

When the user purchasing the paid contents accesses the content distributor's (seller's) site again, the wireless communication device 100 transmits the transfer trace information to the server of the content distributor. Since the transfer trace information contains the number of times of data transfer, the content distributor can grasp how many times the free part of the paid contents has been transferred.

After the processing in the flowchart of FIG. 3 is terminated, when the user makes a new transfer request, the processing after step S12 is performed again.

In this way, according to the present embodiment, when the user is authorized user, the control unit 14 activates the wireless communication unit 11, while when the user is not authorized user, the control unit 14 does not activate the wireless communication unit 11. Then, the control unit 14 activates the wireless communication unit 11, then determines whether a transfer permission is present based on the transfer-permitting information of the setting parameters associated with the data, causes the wireless communication unit 11 to transfer the data when it is determined that a transfer permission is present, and does not cause the wireless communication unit 11 to transfer the data when it is determined that a transfer permission is not present.

Thereby, since the data transfer can be managed, careless use which can transfer the data to an unintended third party or unexpected use by other than the authorized user can be addressed, thereby performing data transfer or data management more safely and securely. That is, the data of the contents which should be protected and managed can be distributed and shared according to the intention of the content creator or distributor.

The highly reliable secure system which can be used only by the authorized users can be realized so that even when the accounting/authenticating system using NFC is combined with the wireless communication device 100, unauthorized use by other than the authorized users can be prevented.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A wireless communication device comprising:
a wireless communication unit configured to perform close proximity wireless communication or near-distance wireless communication with other wireless communication device;
a control unit configured to control the wireless communication unit; and
a storage unit configured to store data and setting parameters associated with the data,
wherein the setting parameters comprise presence or absence of a lock function and transfer-permitting information,
the control unit confirms whether a user is an authorized user of the device, activates the wireless communication unit when the user is the authorized user, and does not activate the wireless communication unit when the user is not the authorized user,
after the control unit activates the wireless communication unit, when the lock function is present in the setting parameters, the control unit determines whether a transfer permission is present based on the transfer-permitting information in the setting parameters,
when determining that the transfer permission is present, the control unit causes the wireless communication unit to transfer the data, and
when determining that the transfer permission is not present, the control unit does not cause the wireless communication unit to transfer the data.

2. The wireless communication device according to claim 1, wherein
the storage unit stores an activation code specific to the authorized user and identification information specific to the device, and
when a calculation result, obtained by making a predetermined calculation between the activation code and the identification information, corresponds to user information input by the user for login, the control unit confirms that the user is the authorized user.

3. The wireless communication device according to claim 1, wherein
when the lock function is not present in the setting parameters, the control unit causes the wireless communication unit to transfer the data.

4. The wireless communication device according to claim 1, wherein
the setting parameters comprise presence or absence of an encryption instruction,
when the control unit determines that the transfer permission is present, the control unit confirms whether an encryption instruction is present in the setting parameters,
when the encryption instruction is present, the control unit encrypts the data and causes the wireless communication unit to transfer the encrypted data, and
when the encryption instruction is not present, the control unit causes the wireless communication unit to transfer the data without encryption.

5. The wireless communication device according to claim 1, wherein
the storage unit stores transfer trace information associated with the data, the transfer trace information comprising information on transfer of the data, and
after the data transfer is completed, the control unit records the information on transfer of the data in the transfer trace information.

6. The wireless communication device according to claim 5, wherein
the control unit reads the transfer trace information from the storage unit before determining whether the transfer permission is present after activating the wireless communication unit, and
the control unit determines whether the transfer permission is present based on the transfer-permitting information and the read transfer trace information.

7. The wireless communication device according to claim 6, wherein
the transfer-permitting information comprises presence or absence of an initial transfer permission and the permitted number of times of transfer,
the transfer trace information comprises the number of times of the data transfer as the information associated with the data transfer,
the control unit determines that the transfer permission is present when the initial transfer permission is present and the number of times of the data transfer in the transfer trace information is less than the permitted number of times of transfer, and
the control unit determines that the transfer permission is not present when the initial transfer permission is not present and the number of times of the data transfer is equal to or more than the permitted number of times of transfer.

8. The wireless communication device according to claim 5, wherein
when determining that the transfer permission is not present, the control unit records the number of ignored transfer requests as the information associated with the data transfer in the transfer trace information.

9. The wireless communication device according to claim 1, wherein
the transfer-permitting information comprises a permitted data range,
the permitted data range is information indicating all the data or part of the data, and
when determining that the transfer permission is present, the control unit causes the wireless communication unit to transfer the data in the permitted data range.

10. The wireless communication device according to claim 9, wherein
the data is data of a paid content,
the paid content comprises a transferable free part, and
the free part is set in the permitted data range.

11. The wireless communication device according to claim 1, wherein
the data is data of a paid content, a free content or a user-created content, and
the paid content, the free content and the user-created content comprise music, an image, an animation, a map, an electronic book or a software.

12. The wireless communication device according to claim 1, wherein
the data is data of a paid content, and
the setting parameters are set by a content distributor and the user cannot change the setting parameters.

13. The wireless communication device according to claim 3, wherein
when the lock function is not present, the data is data of a free content or a user-created content.

14. The wireless communication device according to claim 1, wherein
when determining that the transfer permission is not present, the control unit notifies an alarm to the user.

15. The wireless communication device according to claim 14, wherein
the alarm is a sound or a screen display.

16. The wireless communication device according to claim 1, wherein
after causing the wireless communication unit to transfer the data, the control unit notifies transfer completion to the user.

17. The wireless communication device according to claim 16, wherein
the control unit notifies the transfer completion by a sound or a screen display.

18. The wireless communication device according to claim 1, wherein
the wireless communication device and the other wireless communication device use the same wireless communication system of TransferJet to perform the close proximity wireless communication.

19. The wireless communication device according to claim 1, wherein
the wireless communication device and the other wireless communication device use the same wireless communication system of Bluetooth or wireless LAN to perform the near-distance wireless communication.

20. A wireless communication method in a wireless communication device comprising a wireless communication unit configured to perform close proximity wireless communication or near-distance wireless communication with other wireless communication device, a control unit configured to control the wireless communication unit, and a storage unit configured to store data and setting parameters associated with the data, the setting parameters comprising presence or absence of a lock function and transfer-permitting information, the method comprising:
confirming whether a user is an authorized user of the device, activating the wireless communication unit when the user is the authorized user, and not activating the wireless communication unit when the user is not the authorized user;
after activating the wireless communication unit, when the lock function is present in the setting parameters, determining whether a transfer permission is present based on the transfer-permitting information in the setting parameters;
when it is determined that the transfer permission is present, causing the wireless communication unit to transfer the data; and
when it is determined that the transfer permission is not present, not causing the wireless communication unit to transfer the data.
